(19) United States
(12) Patent Application Publication
(10) Pub. No.: US 2008/0079840 A1
(43) Pub. Date: Apr. 3, 2008

(54) Focus detection device

(75) Inventors: Mitsutomo Kariya, Tokyo (JP); Kosei Tamiya, Sagamihara-shi (JP); Tatsuya Takei, Tokyo (JP); Masato Osawa, Tokyo (JP); Hitoshi Tsuchiya, Tokyo (JP); Tetsuo Kikuchi, Tokyo (JP); Koichi Nakata, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Olympus Imaging Corp., Tokyo (JP); Olympus Corporation, Tokyo (JP)

(21) Appl. No.: 11/906,236

(22) Filed: Oct. 1, 2007

(30) Foreign Application Priority Data
Oct. 3, 2006 (JP) 2006-271976
Oct. 4, 2006 (JP) 2006-272812

(51) Int. Cl. H04N 5/335

(52) U.S. Cl. 348/345; 348/E05.091

(57) ABSTRACT

There is disclosed a focus detection device having a light receiving section in which charges are generated and accumulated based on quantities of received lights and a charge accumulating section in which the charges accumulated in the light receiving section are transferred and accumulated. The focus detection device starts the accumulation of the charge in the light receiving section, when the charge accumulating section retains a reset state, and the device cancels the reset state of the charge accumulating section at a predetermined timing before the charges accumulated in the light receiving section are transferred to the accumulating section

Moreover/alternatively, a focus detection device using a plurality of photo sensors is disclosed. A phase of a reading signal of a part of the photo sensors is different from that of a reading signal of another part.

### CROSS-REFERENCE TO RELATED APPLICATION

This application is based upon and claims the benefit of priority from prior Japanese Patent Application No. 2006-271976 filed on Oct. 3, 2006, and No. 2006-272812 filed on Oct. 4, 2006, the entire contents of which are incorporated herein by reference.

### BACKGROUND OF THE INVENTION

1. Field of the Invention

The present invention relates to a focus detection device. More particularly, it relates to a focus detection device capable of detecting focusing states of a plurality of focusing points in a photographing screen of a camera.

2. Description of the Related Art

In recent years, with sophistication of a performance and a function of a camera, there have been various proposals concerning a focus detection device capable of detecting focusing states of many focusing points in a photographing screen.

For example, in Japanese Patent Application Laid-Open No. 2-907, a focus detection device is disclosed which has an integration clear gate for each focus detecting section and in which a voltage is applied to the integration clear gate simultaneously with the start of accumulation to cancel charge reset of a charge accumulating section.

Moreover, in Japanese Patent Application Laid-Open No. 10-333022, there is disclosed a technology in which a two-chip constitution of the AF sensor and a microcomputer is used, and analog signals of focusing points are obtained in parallel to convert the signals-into digital signals by an A/D converter incorporated in a microcomputer via selection means (a multiplexer) incorporated in an AF sensor.

Furthermore, in Japanese Patent Application Laid-Open No. 10-123580, there is disclosed a technology of sample-holding a pair of sensor outputs at a frequency n times as much as a CCD transfer timing, and converging the two sensor pair outputs into one signal line in a time division manner to convert the converged signal into the digital signal with one A/D converter.

### BRIEF SUMMARY OF THE INVENTION

A focus detection device of the present invention has a light receiving section in which charges are generated and accumulated in accordance with quantities of received lights and a charge accumulating section in which the charges accumulated in the light receiving section are transferred and accumulated, the light receiving section starts the accumulation of the charges while the charge accumulating section is reset, and the reset state of the charge accumulating section is canceled at a predetermined timing before the charges accumulated in the light receiving section are transferred to the accumulating section.

Moreover/alternatively, a focus detection device of the present invention uses a plurality of photo sensors, and a reading signal of a part of the photo sensors has a phase different from that of a reading signal of other part.

One example of a constitution of the present invention can be described as follows. A focus detection device comprising: a photoelectric conversion element row of a charge accumulation type having a light receiving section which receives luminous fluxes transmitted through different pupil areas of a photographing lens to generate charges in accordance with quantities of received lights, a charge accumulating section which accumulates the charges generated in the light receiving section, a charge transfer section which transfers the charges generated in the light receiving section to the charge accumulating section, and a charge reset section which resets the charges present in the charge accumulating section; an accumulation control section which controls an accumulating operation of the photoelectric conversion element row; and a focus detecting section which performs focus detection based on an output corresponding to the accumulated charges successively transferred from the photoelectric conversion element row, wherein the charge reset section cancels the reset of the charge accumulating section at a timing after the start of the accumulation, which accumulation timing is controlled by the accumulation control section, and before the transfer of the charges, and the charge transfer section transfers the charges from the light receiving section to the charge accumulating section after the charge reset section cancels the reset.

Moreover, another example of the constitution of the present invention can be described as follows. A focus detection device comprising: an image sensor having a plurality of photoelectric conversion element rows of a charge accumulation type and configured to generate an analog signal corresponding to accumulated charges; a charge transfer shift pulse generating section which generates a charge transfer shift pulse to successively transfer and output the accumulated charges of the plurality of photoelectric conversion element rows; an A/D converter which converts, into digital signals, a plurality of analog signals output from the image sensor corresponding to the plurality of photoelectric conversion element rows in a time division manner; and a focus detecting section which performs focus detection based on the digital signals output from the A/D converter, wherein the charge transfer shift pulse generating section outputs the charge transfer shift pulse to each of the plurality of photoelectric conversion element rows such that the charge transfer shift pulses input to a part of the photoelectric conversion element rows have a displaced phase against the charge transfer shift pulses input to the other photoelectric conversion element rows.

The present invention can also be understood as a method of controlling a photo sensor for use in the focus detection device.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing an AF peripheral constitution example including a schematic mechanism of a camera system to which a focus detection device of a multiple AF system according to an embodiment of the present invention is applied;

FIG. 2 is a perspective view schematically showing a secondary image forming system of an AF optical system;

FIG. 3 is a perspective view showing a behavior of a plurality of focusing points in a photographing screen;

FIG. 4 is a schematic diagram showing a sensor arrangement example in which focused states of the focusing points shown in FIG. 3 are detected;

FIG. 5 is a schematic block diagram showing a signal transmission and reception relation between an AF sensor and an AF controller;

FIG. 6 is a diagram showing a sensor circuit constitution example of a line sensor portion including rows each having five pixels and extracted from a horizontal base sensor array and a horizontal reference sensor array of the AF sensor;

FIG. 7 is a time chart showing a charge transfer shift pulse example in a horizontal direction and a vertical direction;

FIG. 8 is a time chart showing a sampling pulse example and an analog data example in a horizontal direction and a vertical direction;

FIG. 9 is a schematic block diagram showing a constitution example of a control system in the AF sensor;

FIG. 10 is a schematic time chart showing an operation control example of the present embodiment; and

FIG. 11 is a schematic time chart showing a conventional operation control example.

### DETAILED DESCRIPTION OF THE PREFERRED EMBODIMENT

Preferred embodiments of the invention are described below with reference to the accompanying drawings.

The present embodiment is not limited to the present embodiment, and can variously be changed without departing from the scope of the present invention.

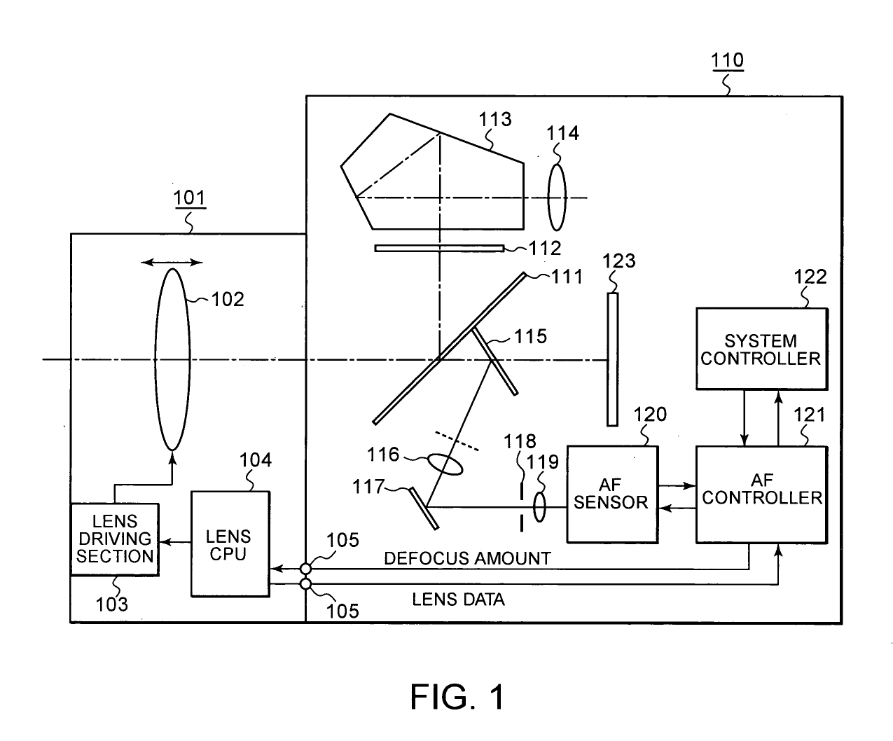

FIG. 1 is a block diagram of a camera system to which a focus detection device of a multiple AF system of the present embodiment is applied, schematically showing an AF peripheral constitution and mechanism. Here, an example of a case where a TTL phase difference AF system is applied to a single lens reflex camera is described.

As shown in FIG. 1, a camera system of the present embodiment includes an interchangeable lens 101 and a camera body 110. The interchangeable lens 101 is detachably attached to the camera body 110 via a camera mount (not shown) disposed at a front surface of the camera body 110. In the interchangeable lens 101, a photographing lens 102, a lens driving section 103 and a lens CPU 104 are disposed.

The photographing lens 102 is a lens for focus adjustment included in a photographing optical system, and is driven in an optical axis direction (an arrow direction of FIG. 1) of the photographing lens 102 by a motor (not shown) disposed in the lens driving section 103. Here, an actual photographing optical system includes a plurality of lenses, but FIG. 1 shows the only one lens for focus adjustment as the photographing lens 102.

The lens driving section 103 has a motor and a driving circuit (a motor driver) of the motor. The lens CPU 104 is a control circuit which controls the lens driving section 103, and can communicate with an AF controller 121 disposed in the camera body 110 via communication connectors 105. From this lens CPU 104 to the AF controller 121, communication of lens data such as manufacturing fluctuation information of the photographing lens 102 and aberration information, for example these information is stored in the lens CPU 104 beforehand, is performed.

On the other hand, the camera body 110 is provided with a main mirror 111 positioned along an optical axis of the photographing lens 102. The main mirror 111 is rotatably disposed as a movable mirror. A middle portion of the main mirror is a half mirror, and a part of entering luminous fluxes passes through the portion of the half mirror.

When the main mirror 111 is disposed at a downward position as shown in FIG. 1, a part of the luminous fluxes from a subject (not shown), which has entered the camera body 110 via the photographing lens 102 of the interchangeable lens 101, is reflected by the main mirror 111. This reflected light reaches an eyepiece lens 114 via a focusing screen 112 and a penta prism 113. In consequence, an operator can observe a state of the subject.

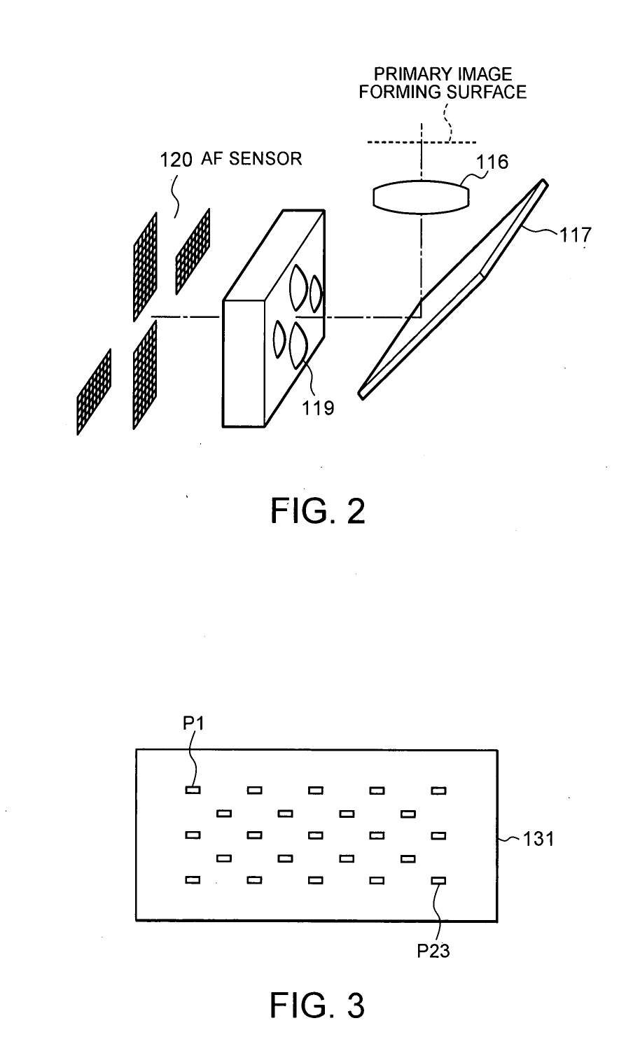

Furthermore, another part of the luminous fluxes which has reached the main mirror 111 passes through the half mirror portion, is reflected by a sub-mirror 115 installed on the back surface of the main mirror 111, and is guided into an AF optical system which performs automatic focus detection (AF). The AF optical system has a condenser lens 116, a reflection mirror 117, separator aperture stops 118 constituting two pairs of aperture stops and separator lenses 119 constituting two pairs of image re-forming lenses. This AF optical system will be described with reference to FIGS. 2, 3.

FIG. 2 is a perspective view schematically showing a secondary image forming system of the AF optical system, and FIG. 3 is an explanatory view showing an arrangement of a plurality of focusing points (a focus detection area) in a photographing screen. The luminous fluxes reflected by the sub-mirror 115 are formed into an image on a primary image forming surface shown by a broken line in FIG. 2. The luminous fluxes of the subject formed into the image on the primary image forming surface are condensed by the condenser lens 116 and totally reflected by the reflection mirror 117. Afterward, the luminous fluxes are pupil-divided by two pairs of separator aperture stops 118 (see FIG. 1) at an exit pupil (not shown) of the photographing lens 102 which has an optically conjugate relation with respect to the separator aperture stops 118 and the primary image forming surface. The luminous fluxes of the subject pupil-divided by the separator aperture stops 118 are formed into an image again by the separator lenses 119 to incident on a predetermined area of an AF sensor 120 disposed behind the AF optical system.

The AF sensor 120 can detect focused states of a plurality of focusing points P1 to P23 in a photographing screen 131 shown in, for example, FIG. 3 (the AF sensor 120 will be described later in detail).

A focus detection method of a TTL phase difference detection system has been described above. As described above, a part of the luminous fluxes from the subject passes through two pairs of separator aperture stops 118 and two pairs of pupil areas of the photographing lens 102 which is optically conjugate with respect to the primary image forming surface, and is received by the AF sensor 120.

In the AF sensor 120, the luminous fluxes from the subject are converted into an analog electric signal by photoelectric conversion. An output of the AF sensor 120 is input into the AF controller 121 which is a focus detecting section to calculate a defocus amount. An operation of this AF controller 121 is controlled by a system controller 122.

The defocus amount obtained by the AF controller 121 is transmitted to the lens CPU 104. The lens CPU 104 calculates a motor driving amount for driving the photographing lens 102 based on the received defocus amount. The lens CPU 104 drives focusing of the photographing lens 102 via the lens driving section 103 based on the calculated motor driving amount.

Furthermore, in FIG. 1, when the main mirror 111 retreats from an optical path of the photographing lens 102 and is disposed at an upward position, the luminous fluxes from the subject which have struck via the photographing lens 102 form an image on an image pickup device 123 and is photoelectrically converted. An image pickup signal obtained at the image pickup device 123 is input into the system controller 122, subjected to predetermined image processing, and recorded in a recording medium (not shown) to perform photographing.

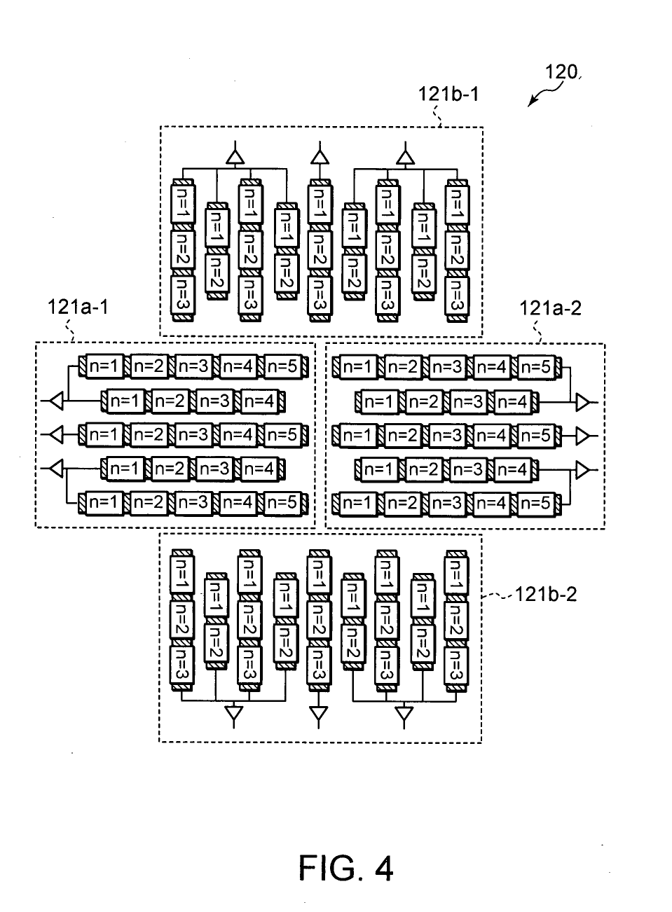

Next, the AF sensor 120 will be described. FIG. 4 is a schematic diagram showing an arrangement example of sensors arranged in order to detect focused states of 23 focusing points P1 to P23 shown in FIG. 3. The AF sensor 120 of the present embodiment has a horizontal base sensor array 120a-1 and a horizontal reference sensor array 120a-2 arranged along a horizontal direction of the photographing screen 131, and a vertical base sensor array 120b-1 and a vertical reference sensor array 120b-2 arranged along a vertical direction of the photographing screen 131. It is to be noted that the horizontal base sensor array 120a-1 and the horizontal reference sensor array 120a-2 form a pair, and the vertical base sensor array 120b-1 and the vertical reference sensor array 120b-2 form a pair. According to such an arrangement constitution of two pairs of sensor units, the focused states of 23 focusing points P1 to P23 shown in FIG. 3 can be detected, and focus detection precision is improved.

Moreover, as shown in FIG. 4, an output section is constituted so that outputs from the pixel rows of a base section of each pair of sensor units are successively directed toward a side opposite to a side on which the pixel rows of a reference section are arranged, that is, a side on which any pixel row of the reference section does not exist. Similarly, an output section is constituted so that outputs from the pixel rows of the reference section are successively directed toward a side opposite to a side on which the pixel rows of the base section are arranged.

Here, each of the horizontal base sensor array 120a-1 and the horizontal reference sensor array 120a-2 includes rows of 23 pixels constituted by alternately arranging a line sensor including a row of five pixels and a line sensor including a row of four pixels in accordance with the horizontal arrangement of 23 focusing points P1 to P23 shown in FIG. 3. Each of the vertical base sensor array 120b-1 and the vertical reference sensor array 120b-2 includes rows of 23 pixels constituted by alternately arranging a line sensor including a row of three pixels and a line sensor including a row of two pixels in accordance with the vertical arrangement of 23 focusing points P1 to P23 shown in FIG. 3. It is to be noted that a plurality of rows (photoelectric conversion element rows of a charge accumulation type) of pixels corresponding to the focusing points will hereinafter be referred to “islands” if necessary. Therefore, the number of the islands of the whole AF sensor 120 of the present embodiment having the 23 focusing points P1 to P23 is 23.

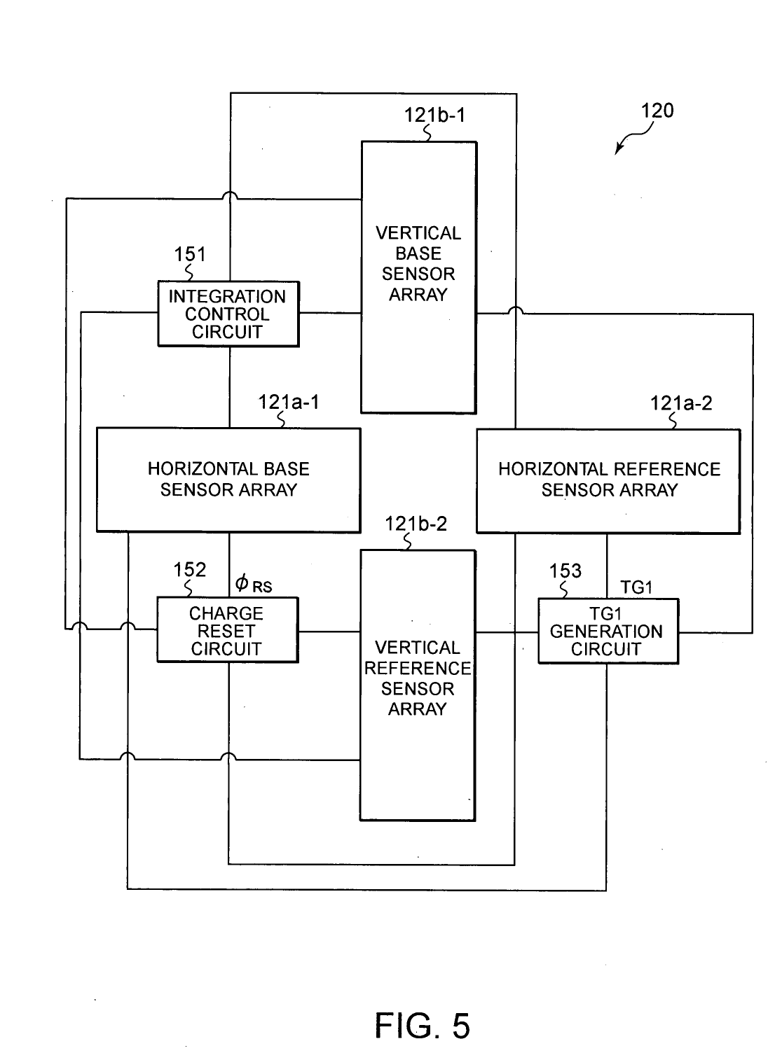

FIG. 5 is a schematic block diagram showing a constitution example of a control system of the AF sensor 120 of FIG. 4. The horizontal base sensor array 120a-1, the horizontal reference sensor array 120a-2, the vertical base sensor array 120b-1 and the vertical reference sensor array 120b-2 are connected to an integration control circuit 151, a charge reset circuit 152 and a TG1 generation circuit 153, respectively.

Here, the charge reset circuit 152 disposed as a charge reset section outputs a reset signal ΦRS for resetting charges present in a charge accumulating section included in each sensor array as described later. In the present embodiment, the charge reset circuit 152 is provided with a wiring line so as to output the reset signal ΦRS in common to all the pixel rows included in the horizontal base sensor array 120a-1, the horizontal reference sensor array 120a-2, the vertical base sensor array 120b-1 and the vertical reference sensor array 120b-2.

The TG1 generation circuit 153 generates a pulse signal TG1 for transferring the charges from photodiodes described later to the charge accumulating section, and constitutes a charge transfer section together with a transfer switch. The TG1 generation circuit 153 emits independent outputs to the pixel rows disposed in the horizontal base sensor array 120a-1, the horizontal reference sensor array 120a-2, the vertical base sensor array 120b-1 and the vertical reference sensor array 120b-2, respectively.

The integration control circuit 151 disposed as an accumulation control section controls the accumulation (integration) of the pixel rows of the sections of the horizontal base sensor array 120a-1, the horizontal reference sensor array 120a-2, the vertical base sensor array 120b-1 and the vertical reference sensor array 120b-2 to acquire outputs corresponding to the respective pixel rows.

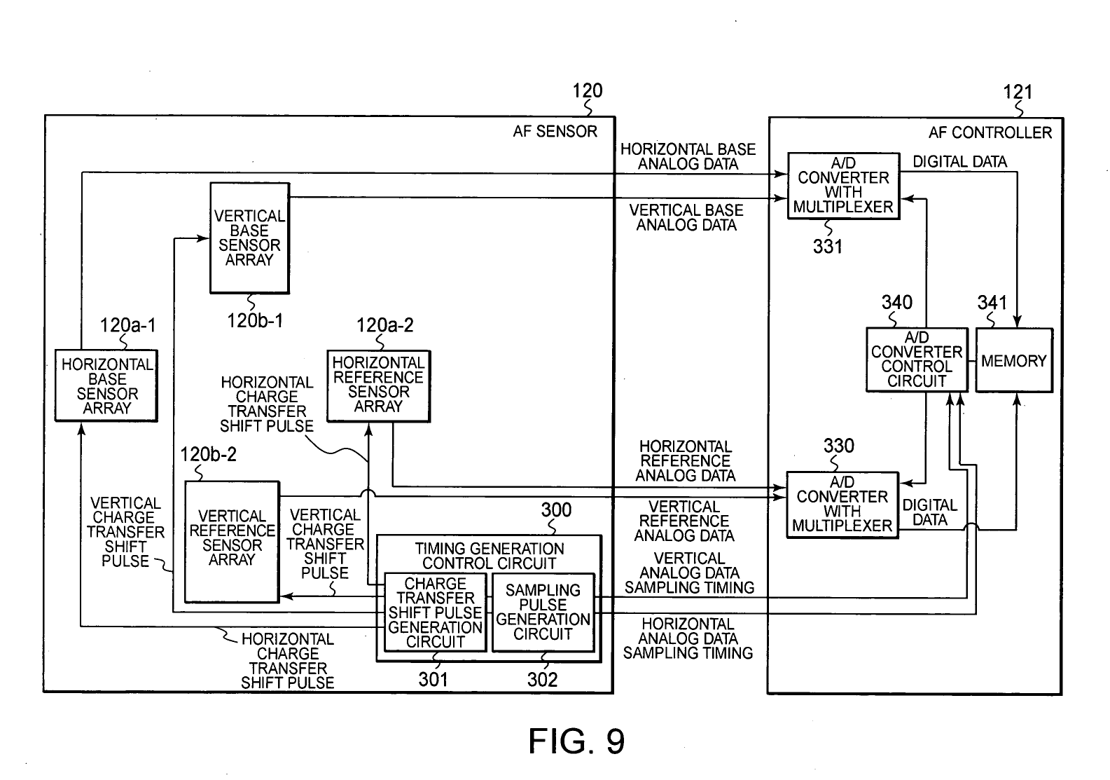

FIG. 9 is a schematic block diagram showing a signal transmission and reception relation between the AF sensor 120 and the AF controller 121. The AF controller 121 includes two A/D converters 330, 331, an A/D converter control circuit 340 and a memory 341. In the A/D converter 331, horizontal base analog data from the horizontal base sensor array 120a-1 and vertical base analog data from the vertical base sensor array 120b-1, these arrays are one half of the pair in the AF sensor 120, are input as analog signals. The A/D converter 331 subjects the analog signals to sampling processing to convert the signals into digital signals and output the signals to the memory 341. Similarly, in the A/D converter 330, horizontal reference analog data from the horizontal reference sensor array 120a-2 and vertical reference analog data from the vertical reference sensor array 120b-2, these arrays are the other half of the pair in the AF sensor 120, are input as analog signals. The A/D converter 330 subjects the analog signals to sampling processing to convert the signals into digital signals and output the signals to the memory 341.

Here, each of the A/D converters 330, 331 is an A/D converter provided with a multiplexer section, and performs a function of switching the input analog data for two channels in a time division manner under control of the A/D converter control circuit 340. The A/D converter control circuit 340 controls a sampling operation of the analog signal in the A/D converters 330, 331.

On the other hand, the AF sensor 120 includes a timing generation control circuit 300 in addition to four sensor arrays 120a-1 to 120b-2. This timing generation control circuit 300 includes a charge transfer shift pulse generation circuit 301 and a sampling pulse generation circuit 302. The charge transfer shift pulse generation circuit 301 generates and outputs charge transfer shift pulses to successively transfer and output accumulated charges obtained for each pixel to the four sensor arrays 120a-1 to 120b-2, respectively. The sampling pulse generation circuit 302 generates sampling pulses for A/D conversion start timings when A/D converters 330, 331 sample analog data input from the AF sensor 120 to convert the data into digital data. The A/D converter control circuit 340 controls sampling operations (A/D converting operations) of the A/D converters 330, 331 in response to the sampling pulses generated by the sampling pulse generation circuit 302.

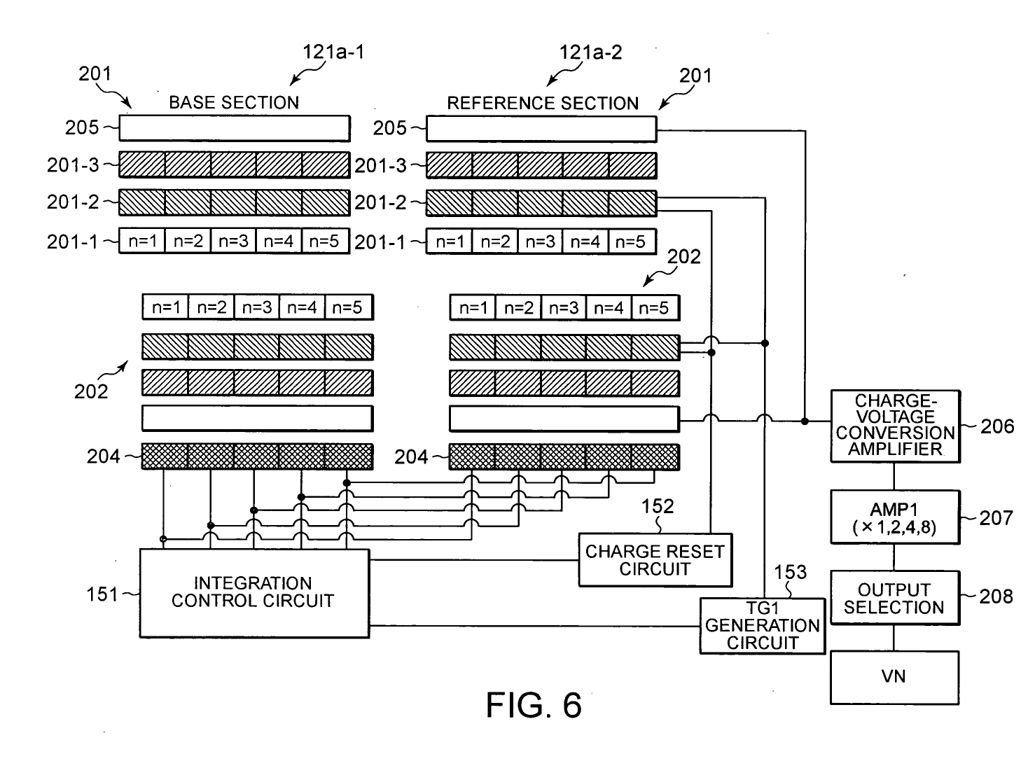

FIG. 6 is a diagram showing a sensor circuit constitution example of a line sensor portion including rows each having five pixels and extracted from a part of the AF sensor 120, for example, the horizontal base sensor array 120a-1 and the horizontal reference sensor array 120a-2. It is to be noted that islands n shown in FIG. 6 correspond to islands n shown in FIG. 4.

Here, in the present embodiment, in order to improve focus detection precision, two line sensors 201, 202 per pixel row (island) are arranged so as to be displaced in a transverse direction. That is, with regard to the two line sensors 201, 202, the line sensor 202 is arranged so as to be displaced as much as a ½ pixel from the line sensor 201. In this manner, correlating calculation is performed in each of the line sensors 201, 202 for two lines arranged so as to be displaced from each other in the transverse direction to detect image deviation amounts and obtain an average value of the two image deviation amounts. In consequence, sensor noises (mainly shot noises) can be reduced to 1/(√2), and an amount of errors which appear in a one-pixel period can be reduced.

Moreover, as shown in FIG. 6, the pixel rows (the islands) of the line sensor 201 include a plurality of photodiodes 201-1 which constitute pixels, respectively, a charge accumulating section 201-2, a transfer switch 201-3 and a charge transfer path 205. This also applies to the pixel rows (the islands) of the line sensor 202.

Furthermore, photodiodes 204 for monitoring are arranged in the vicinity of each line sensor 202. The photodiodes 204 for monitoring are arranged so as to perform a monitor operation of controlling an accumulation time of the photodiodes 201-1 of the respective pixel rows (islands). The photodiodes 204 for monitoring are arranged for island units so as to control the pixels of the same island so that the pixels have an equal accumulation time. The integration control circuit 151 into which outputs of the photodiodes 204 for monitoring are input judges, based on the outputs of the monitoring photodiodes 204 for each pixel row (island), whether or not the accumulation of each of the photodiodes 201-1 ends. In consequence, the integration control circuit 151 has a function of recognizing the first accumulated pixel row and the accumulation end timing of the row among all of the pixel rows.

It is to be noted that the integration control circuit 151 outputs a signal to end a charge accumulating operation (an integrating operation), even when the outputs of the photodiodes 204 for monitoring do not reach predetermined threshold values and a predetermined integration time elapses. The threshold value for ending the charge accumulating operation and the integration time can be changed.

In addition, the photodiodes 201-1 arranged for the respective pixel units obtain photo charges based on light quantities of the luminous fluxes of the subject which have entered the photodiodes 201-1. The photodiodes 201-1 constitute a light receiving section which receives the luminous fluxes transmitted through different pupil areas of the photographing lens 102 to generate the charges based on the quantities of the received lights. The charge accumulating section 201-2 temporarily accumulates the photo charges obtained by the photodiodes 201-1, respectively. Here, unnecessary charges of the charge accumulating section 201-2 are reset by setting, to an H-level, the reset signal ΦRS from the charge reset circuit 152 to the charge accumulating section 201-2.

The TG1 generation circuit 153 generates the pulse signal TG1 at the accumulation end timing of the photodiodes 201-1 of the respective islands based on the outputs of the photodiodes 204 for monitoring. In this case, the photo charges generated in the photodiodes 201-1 are transferred to the charge accumulating section 201-2 in the same island. The charge accumulating section 201-2 on an output side is connected to the charge transfer path 205 via the transfer switch 201-3. The transfer switch 201-3 outputs the charges accumulated in the charge accumulating section 201-2 once at a predetermined timing (not shown), and transfers the charges to the charge transfer path 205.

On an output side of the charge transfer path 205, a charge-voltage conversion amplifier 206 into which the photo charges are transferred as much as one pixel every time the charge transfer shift pulse is applied is disposed. On an output side of the charge-voltage conversion amplifier 206, an amplification circuit (AMP1) 207 and an output selection circuit 208 are arranged in order. After a voltage signal converted by the charge-voltage conversion amplifier 206 is amplified at a predetermined amplification factor (e.g., 1, 2, 4 or 8 folds is selected) in the amplification circuit 207, the signal is input into the output selection circuit 208. In the output selection circuit 208, after a temperature of the voltage signal input for the pixel unit is compensated based on the temperature detected by a temperature sensor (not shown), an output voltage VN is output to the A/D converter 330 or 331 of the AF controller 121 at the subsequent stage via a terminal VN.

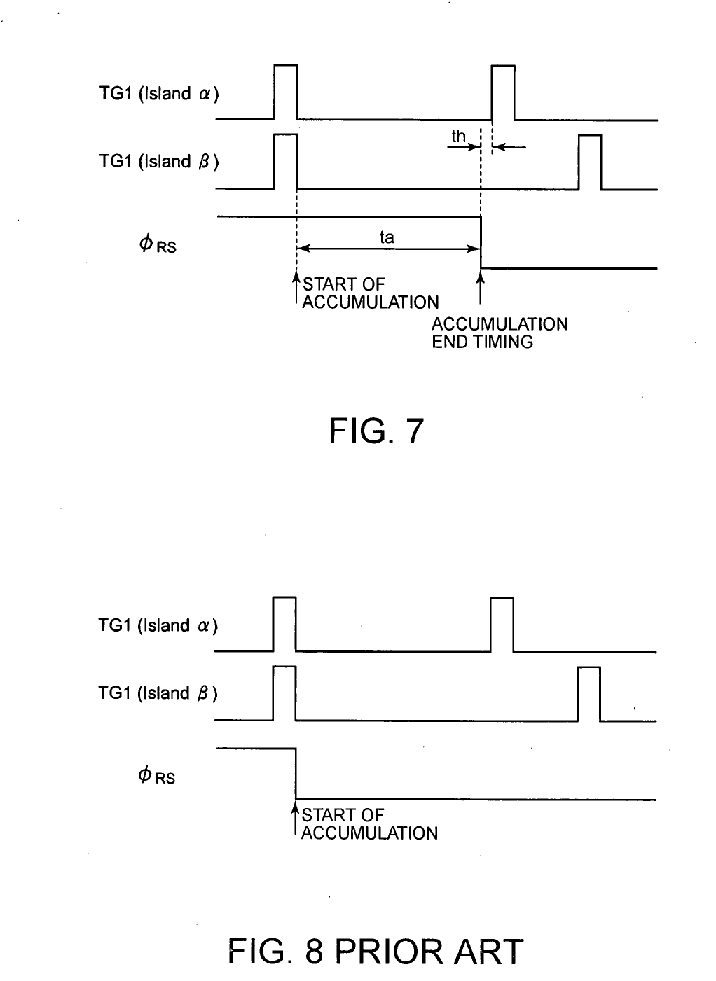

Here, an operation control example of a charge reset operation of the charge accumulating section 201-2 of the focus detection device according to the present embodiment will be described in comparison with a conventional operation control example. FIG. 7 is a schematic time chart showing the operation control example of the present embodiment, and FIG. 8 is a schematic time chart showing a conventional operation control example. It is to be noted that in FIGS. 7 and 8, “TG1 (Island α)” indicates the island which first ends the accumulation, and “TG1 (Island β)” indicates another island.

First, at the start of the accumulation operation, the accumulation operations of all of the islands are simultaneously started. The TG1 generation circuit 153 outputs the pulse signals TG1 to all of the islands at once. The pulse signals TG1 are output so as to transfer the charges from the photodiodes 201-1 to the charge accumulating section 201-2. Here, in a conventional technology shown in FIG. 8, at the start of the accumulating operation described above, the reset signal ΦRS is canceled (switched to an L-level), and the reset of the charge accumulating section 201-2 is canceled. In consequence, even during the accumulation of the charges in the photodiodes 201-1 after the start of the accumulating operation, dark currents of the charge accumulating section 201-2 continue to increase.

On the other hand, in the present embodiment, as shown in FIG. 7, at the start of the accumulation, the charge reset circuit 152 does not cancel the reset signal ΦRS but cancels the reset signal ΦRS at the accumulation end timing which is a timing th immediately before the charge transfer to the charge accumulating section 201-2, and cancels the charge reset of the charge accumulating section 201-2.

Especially in the present embodiment, in a case where the island α which has first ended the accumulation is detected from all of the islands under monitoring control of the integration control circuit 151, the charge reset circuit 152 cancels the reset signal ΦRS to the charge accumulating section 201-2 for all of the islands at the accumulation end timing of the island α regardless of the end of the accumulation of the other island β. That is, the charge accumulating section 201-2 has a reset state (the H-level) even from the start of the accumulation to the end of the first accumulation, and the unnecessary charges of the charge accumulating section 201-2 are not accumulated.

After the charge reset of the charge accumulating section 201-2 is canceled based on the accumulation end timing, the TG1 generation circuit 153 successively outputs the pulse signals TG1 for charge transfer of each island to transfer the charges from the photodiodes 201-1 to the charge accumulating section 201-2. After the charges are transferred, the transfer switch 201-3 is closed, the photo charges accumulated in the charge accumulating section 201-2 are transferred to the charge transfer path 205, and the above-mentioned processing is subsequently performed.

According to the present embodiment, a timing to cancel the reset of the charge accumulating section 201-2 by the charge reset circuit 152 is not set to the start of the accumulation but is set to the end of the accumulation of the island α immediately before the charge transfer. Therefore, for a time ta shown in FIG. 7, since the charge accumulating section 201-2 continuously has the reset state, the dark current do not continue to increase, the charge accumulating section 201-2 suppresses the generation of the dark current, and noises can be reduced. Especially, the generation of the dark current at the charge accumulating section 201-2 of the island α which has first ended the accumulation can be minimized, and even the charge accumulating section 201-2 of the other island α can be limited to the generation of the dark current from the end of the accumulation to the start of the charge transfer to the charge accumulating section 201-2 itself.

Here, the end of the accumulation of each of the islands is judged, the charge accumulating section 201-2 is beforehand individually provided with a signal line of the reset signal ΦRS, and the reset signal ΦRS is individually canceled at the end of the accumulation, so that the dark currents of the charge accumulating sections 201-2 of all of the islands can be minimized. However, in this case, reset signal lines as many as the islands are required, and a wiring line becomes complicated. Therefore, in the present embodiment, the charge reset circuit 152 outputs the reset signals ΦRS to the charge accumulating sections 201-2 for all of the islands via one common reset signal line, so that the number of the reset signal lines is minimized.

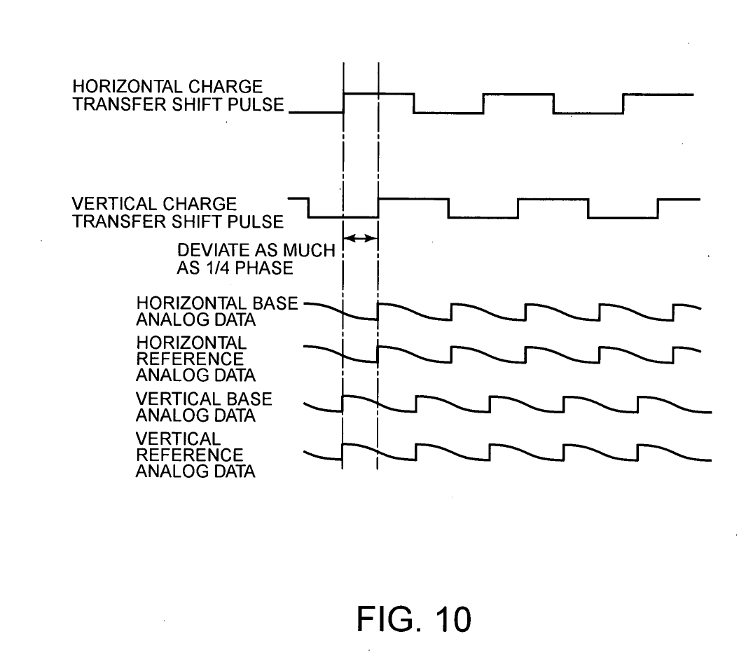

Next, control of the charge transfer shift pulse and the sampling pulse according to the present embodiment will be described. In FIG. 9, the charge transfer shift pulse generation circuit 301 generates the charge transfer shift pulse for a horizontal direction and the charge transfer shift pulse for a vertical direction at timings having phases which deviate from each other. Specifically, as shown in FIG. 10, the horizontal charge transfer shift pulse to be input into the pair of horizontal base sensor array 120a-1 and horizontal reference sensor array 120a-2 is set so as to phase-deviate as much as ¼ phase from the vertical charge transfer shift pulse to be input into the pair of vertical base sensor array 120b-1 and vertical reference sensor array 120b-2.

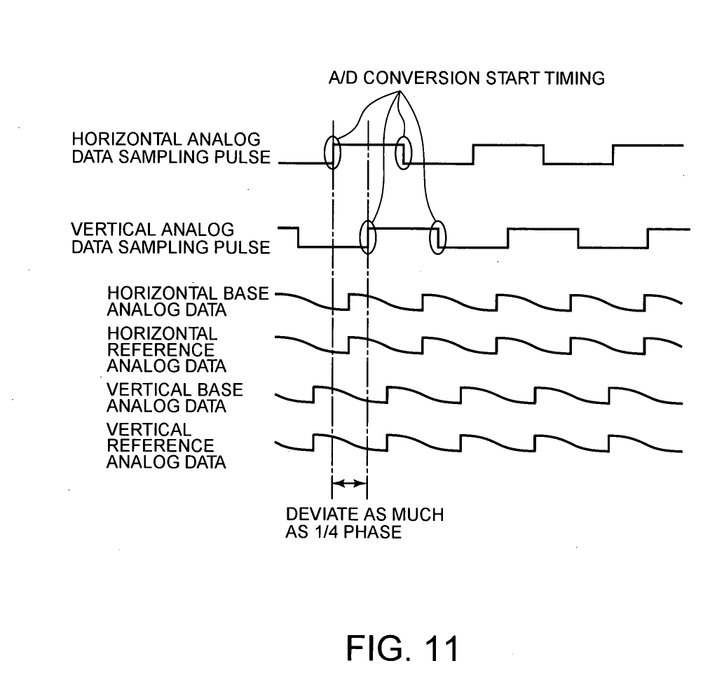

Moreover, in the present embodiment, the sampling pulse generation circuit 302 generates the sampling pulse for the horizontal direction and the sampling pulse for the vertical direction at timings having phases which deviate from each other as in the charge transfer shift pulse generation circuit 301. Specifically, as shown in FIG. 11, the horizontal analog data sampling pulse to be output to the pair of horizontal base sensor array 120a-1 and horizontal reference sensor array 120a-2 is set so as to phase-deviate as much as ¼ phase from the vertical analog data sampling pulse to be output to the other pair of vertical base sensor array 120b-1 and the vertical reference sensor array 120b-2.

A data processing control example of such a constitution with an AF operation will be described. In the charge transfer paths 205 of the respective sensor arrays 120a-1 to 120b-2 of the AF sensor 120, every time the charge transfer shift pulse output from the charge transfer shift pulse generation circuit 301 is applied, the accumulated photo charges are transferred pixel by pixel to the charge-voltage conversion amplifier 206, and converted into a voltage signal. In this case, the horizontal charge transfer shift pulses to be input into the horizontal base sensor array 120a-1 and the horizontal reference sensor array 120a-2 among the sensor arrays 120a-1 to 120b-2 are output at the phase which deviates as much as the ¼ phase from the phase of the vertical charge transfer shift pulses to be input into the vertical base sensor array 120b-1 and the vertical reference sensor array 120b-2.

Moreover, after the voltage signal converted by the charge-voltage conversion amplifier 206 is amplified at a predetermined amplification factor in the amplification circuit 207, the signal is output toward the AF controller 121. At this time, the analog data (horizontal base analog data, horizontal reference analog data, vertical base analog data and vertical reference analog data) to be output to the AF controller 121 from channels of the horizontal base sensor array 120a-1, the horizontal reference sensor array 120a-2, the vertical base sensor array 120b-1 and the vertical reference sensor array 120b-2 is output as the signal having the phase which deviates as much as the ¼ phase in the horizontal direction and the vertical direction as shown in FIG. 10 in accordance with a phase difference due to the charge transfer shift pulse.

As shown in FIG. 11, on the side of the AF controller 121 into which such analog data is to be input, when the horizontal analog sampling pulse from the sampling pulse generation circuit 302 changes (from the L-level to the H-level or the H-level to the L-level), the A/D converter control circuit 340 instructs the A/D converter 331 to start the A/D conversion of the horizontal base analog data. Moreover, the multiplexer section of the A/D converter 331 selects the horizontal base analog data corresponding to the horizontal base sensor array 120a-1 as the analog data to be subjected to time division processing to start the A/D conversion of the data. Simultaneously, the A/D converter control circuit 340 instructs the A/D converter 330 to start the A/D conversion of the horizontal reference analog data, and the multiplexer section of the A/D converter 330 selects the horizontal reference analog data corresponding to the horizontal reference sensor array 120a-2 as the analog data to be subjected to the time division processing to start the A/D conversion of the data.

On the other hand, when the vertical analog sampling pulse from the sampling pulse generation circuit 302 changes (from the L-level to the H-level or the H-level to the L-level), the A/D converter control circuit 340 instructs the A/D converter 331 to start the A/D conversion of the vertical base analog data. Moreover, the multiplexer section of the A/D converter 331 selects the vertical base analog data corresponding to the vertical base sensor array 120b-1 as the analog data to be subjected to time division processing to start the A/D conversion of the data. Simultaneously, the A/D converter control circuit 340 instructs the A/D converter 330 to start the A/D conversion of the vertical reference analog data, and the multiplexer section of the A/D converter 330 selects the vertical reference analog data corresponding to the vertical reference sensor array 120b-2 as the analog data to be subjected to the time division processing to start the A/D conversion of the data.

In these A/D converting operations, the A/D converters 330, 331 execute the A/D conversion at a speed twice or more that of the sampling pulse of the analog signal output from the AF sensor 120.

As described above, in the focus detection device of the present embodiment, the phase of the horizontal charge transfer shift pulses to be input into at least the pair of sensor arrays 120a-1, 120a-2 among the plurality of pairs of sensor arrays 120a-1 to 120b-2 is set to deviate as much as the ¼ phase from the phase of the vertical charge transfer shift pulses to be input into the other pair of sensor arrays 120b-1, 120b-2. Therefore, since the one pair and the other pair among the plurality of pairs of sensor arrays 120a-1 to 120b-2 share the A/D converters 330, 331, respectively, the number of the A/D converters is limited to two at minimum, and the speed of charge transfer processing from the respective sensor arrays 120a-1 to 120b-2 can be increased.

Moreover, with regard to the sampling pulses for sampling of the analog signals to the A/D converters 330, 331, the phase of the horizontal sampling pulses for the analog signals corresponding to at least the pair of horizontal sensor arrays 120a-1, 120a-2 among the plurality of pairs of sensor arrays 120a-1 to 120b-2 is set to deviate as much as the ¼ phase from the phase of the vertical sampling pulses for the analog signals corresponding to the other pair of vertical sensor arrays 120b-1, 120b-2. Therefore, the speed of A/D conversion processing can be increased. As shown in FIG. 10, since an A/D conversion period is not a ¼ phase period but is a frequency of a sampling period of the converter itself, any sample is not held until the sensor data is stabilized. In consequence, A/D conversion can be performed at a stable timing.

It is to be noted that in the present embodiment, as the A/D converters 330, 331, the A/D converters provided with the multiplexers are used, but a multiplexer section may separately be disposed at an input stage of the A/D converter.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A focus detection device comprising:
a photoelectric conversion element row of a charge accumulation type having a light receiving section which receives luminous fluxes transmitted through different pupil areas of a photographing lens to generate charges in accordance with quantities of received lights, a charge accumulating section which accumulates the charges generated in the light receiving section, a charge transfer section which transfers the charges generated in the light receiving section to the charge accumulating section, and a charge reset section which resets the charges present in the charge accumulating section;
an accumulation control section which controls an accumulating operation of the photoelectric conversion element row; and
a focus detecting section which performs focus detection based on an output corresponding to the accumulated charges successively transferred from the photoelectric conversion element row,
wherein the charge reset section cancels the reset of the charge accumulating section at a timing after the start of the accumulation, which accumulation timing is controlled by the accumulation control section, and before the transfer of the charges, and the charge transfer section transfers the charges from the light receiving section to the charge accumulating section after the charge reset section cancels the reset.

2. The focus detection device according to claim 1, wherein the charge reset section cancels the reset at the end of the accumulation immediately before the charge transfer.

3. A focus detection device comprising:
a photoelectric conversion element having a plurality of photoelectric conversion element rows of a charge accumulation type each having a light receiving section which receives luminous fluxes transmitted through different pupil areas of a photographing lens to generate charges in accordance with quantities of received lights, a charge accumulating section which accumulates the charges generated in the light receiving section, a charge transfer section which transfers the charges generated in the light receiving section to the charge accumulating section, and a charge reset section which resets the charges present in the charge accumulating section, the photoelectric conversion element rows of the charge accumulation type being arranged so as to correspond to a plurality of focus detection areas set in a photographing screen;
an accumulation control section which controls an accumulating operation of the photoelectric conversion element rows; and
a focus detecting section which performs focus detection of the plurality of focus detection areas based on an output corresponding to the accumulated charges successively transferred from the photoelectric conversion element rows,
wherein the accumulation control section outputs a signal corresponding to the first end of accumulation among the plurality of photoelectric conversion element rows, the charge reset section cancels the reset of the respective charge accumulating sections of the plurality of the photoelectric conversion element rows in response to the output from the accumulation control section, and the respective charge transfer sections of the plurality of photoelectric conversion element rows transfer the charges from the light receiving section to the charge accumulating section after the charge reset section cancels the reset.

4. The focus detection device according to claim 3, wherein the charge reset section outputs a common reset signal to all of the plurality of photoelectric conversion element rows.

5. The focus detection device according to claim 4, wherein the accumulation control section simultaneously starts accumulating operations of the plurality of photoelectric conversion element rows.

6. A focus detection device comprising:
an image sensor having a plurality of photoelectric conversion element rows of a charge accumulation type and configured to generate an analog signal corresponding to accumulated charges;
a charge transfer shift pulse generating section which generates a charge transfer shift pulse to successively transfer and output the accumulated charges of the plurality of photoelectric conversion element rows;
an A/D converter which converts, into digital signals, a plurality of analog signals output from the image sensor corresponding to the plurality of photoelectric conversion element rows in a time division manner; and
a focus detecting section which performs focus detection based on the digital signals output from the A/D converter,
wherein the charge transfer shift pulse generating section outputs the charge transfer shift pulse to each of the plurality of photoelectric conversion element rows such that the charge transfer shift pulses input to a part of the photoelectric conversion element rows have a displaced phase against the charge transfer shift pulses input to the other photoelectric conversion element rows.

7. The focus detection device according to claim 6, further comprising:
a sampling pulse generating section which generates a sampling pulse for the A/D converter to sample the analog signal input from the image sensor,
wherein the sampling pulse generating section displaces a phase of the sampling pulse for the analog signal corresponding to the part of the photoelectric conversion element rows from a phase of the sampling pulse for the analog signal corresponding to the other photoelectric conversion element rows to output the pulse to the A/D converter.

8. The focus detection device according to claim 6, wherein the A/D converter includes a multiplexer section which switches a plurality of analog signals to be output from the image sensor corresponding to the plurality of photoelectric conversion element rows in a time division manner to input the signals into the A/D converter.

9. The focus detection device according to claim 7, wherein the charge transfer shift pulse generating section displaces the phase of the charge transfer shift pulse as much as ¼ phase.

10. The focus detection device according to claim 9, wherein the sampling pulse generating section displaces the phase of the sampling pulse as much as ¼ phase.

11. The focus detection device according to claim 10, wherein the A/D converter includes a multiplexer section which switches a plurality of analog signals to be output from the image sensor to the plurality of photoelectric conversion element rows in a time division manner to input the signals into the A/D converter.

12. The focus detection device according to claim 11, wherein at least a part of the plurality of photoelectric conversion element rows are arranged in a direction different from that of the other photoelectric conversion element rows.

13. A focus detection device comprising:
an image sensor having a plurality of pairs of photoelectric conversion element rows of a charge accumulation type and configured to generate an analog signal corresponding to an accumulated charge;
a charge transfer shift pulse generating section which generates a charge transfer shift pulse to successively transfer and output the accumulated charges of the plurality of pairs of photoelectric conversion element rows;
a plurality of A/D converters which convert, into digital signals, a plurality of analog signals output from the image sensor in such a manner that a plurality of analog signals corresponding to one part of pairs of photoelectric conversion element rows and another plurality of analog signals corresponding to the other part of the pairs of photoelectric conversion element are converted into digital signals in a time division manner; and
a focus detecting section which performs focus detection based on the digital signals output from the plurality of A/D converters,
wherein the charge transfer shift pulse generating section, among the plurality of pairs of photoelectric conversion element rows, displaces a phase of the charge transfer shift pulse to be input into at least one pair of the photoelectric conversion element rows from a phase of the charge transfer shift pulse to be input into the other pair of photoelectric conversion element rows to output the pulse to each of the photoelectric conversion element rows, and
the plurality of A/D converters convert, into the digital signals, the analog signals output corresponding to the charge transfer shift pulse having the deviated phase from the image sensor in the time division manner.

14. The focus detection device according to claim 13, further comprising:
a sampling pulse generating section which generates a sampling pulse for the A/D converters to sample the analog signals input from the image sensor,
wherein the sampling pulse generating section displaces a phase of the sampling pulse for the analog signal corresponding to the pair of photoelectric conversion element rows among the plurality of pairs of photoelectric conversion element rows from a phase of the sampling pulse for the analog signal corresponding to the other pair of photoelectric conversion element rows to output the pulses to the plurality of A/D converters.

15. The focus detection device according to claim 13, wherein the A/D converter includes a multiplexer section which switches a plurality of analog signals to be output from the image sensor corresponding to the plurality of photoelectric conversion element rows in a time division manner to input the signals into the A/D converter.

16. The focus detection device according to claim 14, wherein the charge transfer shift pulse generating section displaces the phase of the charge transfer shift pulse as much as ¼ phase.

17. The focus detection device according to claim 16, wherein the sampling pulse generating section displaces the phase of the sampling pulse as much as ¼ phase.

18. The focus detection device according to claim 17, wherein the A/D converter includes a multiplexer section which switches a plurality of analog signals to be output from the image sensor corresponding to the plurality of photoelectric conversion element rows in a time division manner to input the signals into the A/D converter.

19. The focus detection device according to claim 18, wherein at least one pair of the photoelectric conversion element rows among the plurality of pairs of photoelectric conversion element rows is arranged in a direction different from that of the other pair of photoelectric conversion element rows.

20. A method of controlling a photo sensor for use in a focus detection device, having a light receiving section in which charges are generated and accumulated based on quantities of received lights and a charge accumulating section in which the charges accumulated in the light receiving section are transferred and accumulated, the method comprising:
starting the accumulation of the charges in the light receiving section, the charge accumulating section being in a reset state at the start of the accumulation;
canceling the reset state of the charge accumulating section at a timing of the end of the charge accumulation of the light receiving section; and
transferring the charges accumulated in the light receiving section to the accumulating section after the reset state of the charge accumulating section is canceled.

21. A method of controlling a plurality of photo sensors for use in a focus detection device, the photo sensors being configured to transfer accumulated charges to the outside in synchronization with pulse signals, the method comprising:
reading the accumulated charges from a part of the plurality of photo sensors in synchronization with a first pulse signal;
reading the accumulated charges from another part of the plurality of photo sensors in synchronization with a second pulse signal having a phase different from that of the first pulse signal; and
digitizing the accumulated charges read in synchronization with the first pulse signal and the accumulated charges read in synchronization with the second pulse signal by one A/D converter in a time division manner.
